(19) United States
(12) Patent Application Publication
(10) Pub. No.: US 2017/0256206 A1
(43) Pub. Date: Sep. 7, 2017

(54) DISPLAY DEVICE AND METHOD

(71) Applicant: SHENZHEN CHINA STAR OPTOELECTRONICS TECHNOLOGY CO. LTD., Shenzhen, Guangdong (CN)

(72) Inventors: Jianhang FU, Shenzhen, Guangdong (CN); Taijiun HWANG, Shenzhen, Guangdong (CN)

(21) Appl. No.: 14/905,198

(22) PCT Filed: Dec. 23, 2015
(86) PCT No.: PCT/CN2015/098405

§ 371 Date: Jan. 14, 2016

(30) Foreign Application Priority Data
Oct. 29, 2015 (CN) 201510718010.3

(51) Int. Cl. G09G 3/3275; G09G 3/3266

(52) U.S. Cl. CPC G09G 3/3275; G09G 3/3266; G09G 2320/0247; G09G 2320/045; G09G 2320/064; G09G 2300/0439

(57) ABSTRACT

The present invention provides a display device, which comprises a display panel, a partitioning module, a data transforming module, a scanning driver, and a data driver. The display panel has M pixel units. The partitioning module partitions the M pixel units into N pixel-unit groups and generates at least one partitioning signal. The data transforming module receives at least one original image data of the M pixel units and generates at least one data transforming signal. The data driver receives the at least one data transforming signal, and transfers the at least one data transforming signal to the M pixel units, to light up each of the N pixel-unit groups only for one frame of X frames of an image period. By randomly selecting pixel units to light up, the image flicker problem is solved.

### BACKGROUND OF THE INVENTION

Field of Invention

The present invention relates to a field of display technology, and in particular to a display device and a display method.

Description of Prior Art

OLEDs (Organic Light Emitting Diodes) alternatingly light up among a plurality frames during an image period, in other words, only a half of the OLEDs light up in each frame, and therefore the lifetime of the OLEDs will be increased. Below is the detailed description of the prior art.

Please refer to FIGS. 1 and 2. FIG. 1 is a drawing of an array 200 of LEDs (Light Emitting Diode) of the prior art. FIG. 2 is a detailed drawing of a sub-pixel unit 100r, 100g, 100b (hereinafter represented by a numeral 100) of FIG. 1. The array 200 of LED comprises a plurality of pixel units 230a, 230b, a plurality of data lines 180,180a, 180b, 180c, 180d, 190e (hereinafter represented by a numeral 180), a plurality of gate lines 190, 190a, 190b, 190c, 190d (hereinafter represented by a numeral 190), and a driving source 160 and a GND 150.

The pixel units 230a, 230b comprise a plurality of first pixel units 230a and a plurality of second pixel units 230b. The first pixel units 230a and the second pixel units are disposed alternately. Each of the pixel units 230a, 230b comprises at least one sub-pixel unit 100. Each sub-pixel unit 100 comprises an LED 170 and a driving circuit 240. The LED could be an ordinary LED or an OLED, etc. Each driving circuit 240 has a first driving TFT 110, a second driving TFT 120, a third driving TFT 130, a fourth driving TFT 140, and a storage capacitor 250. Each driving TFT comprises a gate electrode, a first terminal, and a second terminal. The first terminal of the driving TFT is a source electrode, the second terminal of the driving TFT is a drain electrode.

A terminal of the LED 170 is coupled to a driving source 160.

A first terminal of the third driving TFT 130 is coupled to a data line 180.

A gate electrode of the first driving TFT 110 is coupled to a gate line 190, and a first terminal of the first driving TFT 110 is coupled to a second terminal of the third driving TFT 130.

A first terminal and a second terminal of the fourth driving TFT 140 are coupled with two terminals of the storage capacitor 250, and the second terminal of the fourth driving TFT 140 is coupled to a ground 150.

A gate electrode of the second driving TFT 120 is coupled to a second terminal of the first driving TFT 110 and the first terminal of the fourth driving TFT 140.

A first terminal of the second driving TFT 120 is coupled with a second terminal of the LED, and a second terminal of the second driving TFT 120 is coupled with a GND 150.

A first input terminal of a driving circuit of a sub-pixel unit of the first pixel unit 230a receives a first pulse signal 210, and a second input terminal of the driving circuit of the sub-pixel unit of the first pixel unit 230a receives a second pulse signal 220. A first input terminal of a driving circuit of a sub-pixel unit of the second pixel unit 230b receives the second pulse signal 220, a second input terminal of the driving circuit of the sub-pixel unit of the second pixel unit 230b receives the first pulse signal 210.

FIG. 3 is an effect diagram of the array of LEDs of FIG. 1. For example, in frame (n), the first pixel units 230a are forced to light, and the second pixel units 230b are closed. In other words, two adjacent pixel units (for example, the first pixel units 230a and the second pixel units 230b) are never forced to light at the same time. The difference between frame (n) and frame (n+1) is that the situation of each pixel unit is changed (forced to light or closed). With the alternating enforcement of the LEDs 170 of the two adjacent pixel units, the life of the pixel units are effectively increased, however, some technical issues are generated.

1. For adding the third driving TFT 130 and the fourth driving TFT 140, the aperture ratio (AR) of the pixel unit is decreased; 2. For adding the first pulse signal 210 and the second pulse signal 220, the cost of the driving system is increased.

Hence, it is needed to propose a display device and a method of the same to solve the above issues.

### SUMMARY OF THE INVENTION

The purpose of the present invention is to provide a display device to solve the above issues.

To achieve the above purposes, the present invention provides a display device, which comprises a display panel, a partitioning module, a data transforming module, a scanning driver, and a data driver.

The display panel comprises M pixel units. The partitioning module partitions the M pixel units into N pixel-unit groups and generates at least one partitioning signal. The data transforming module receives at least one original image data of the M pixel units and generates at least one data transforming signal. The data driver receives the at least one data transforming signal, and transfers the at least one data transforming signal to the M pixel units, to light up each of the N pixel-unit groups only for one frame of X frames of an image period.

In one preferred embodiment, the partitioning module generates the N pixel-unit groups according to a random number table.

In one preferred embodiment, the data transforming module generates the at least one data transforming signal according to the at least one original image data of the M pixel units and the at least one partitioning signal.

In one preferred embodiment, N is greater than or equal to 2.

The another purpose of the present invention is to provide a display method, comprising: first, M pixel units of a display panel are partitioned into N pixel-unit groups and at least one partitioning signal is generated by a partitioning module; then, at least one original image data of the M pixel units is received by a data transforming module; then, at least one data transforming signal is generated by the data transforming module according to the at least one original image data of the M pixel units group; then, the at least one data transforming signal is inputted into a data driver; then, the at least one data transforming signal is inputted to the M pixel units by the data driver and at least one scanning signal is inputted to the M pixel units by a scanning driver; finally, each of the N pixel-unit groups lights up sequentially and respectively for one frame of X frames of an image period.

In one preferred embodiment, the partitioning module generates the N pixel-unit groups according to a random number table.

In one preferred embodiment, the data transforming module generates the at least one data transforming signal according to the at least one original image data of the M pixel units and the at least one partitioning signal.

In one preferred embodiment, N is greater than or equal to 2.

Compared with the conventional art, the present invention does not need to dispose an additional driving TFT or an inputting signal, the AR won't be decreased and the system cost won't be increased. In the conventional art, two adjacent pixel units must have reversed lighting states in the same frame (one pixel unit lights up, pixel units adjacent to the one pixel unit are turn off); however, the present invention makes the pixel units have larger flexibility in lighting on/off based on using the partitioning module to partition M pixel units into N pixel-unit groups, according to a random number table. Meanwhile, within each image period, every pixel unit only lights up in one frame once, the purpose of increasing the life of the pixel unit is achieved. Moreover, the partition is done according to the random number table, a technical problem of flicker caused by a fixed pixel-unit groups is able to be eliminated.

### BRIEF DESCRIPTION OF THE DRAWINGS

FIG. 1 is a drawing of an array of LEDs of the conventional art;

FIG. 2 is a detailed drawing of a sub-pixel unit of FIG. 1;

FIG. 3 is an effect diagram of the array of LEDs of FIG. 1;

FIG. 4 is a drawing of a display device of the present invention;

FIG. 5 is a flow diagram of a display method of the present invention.

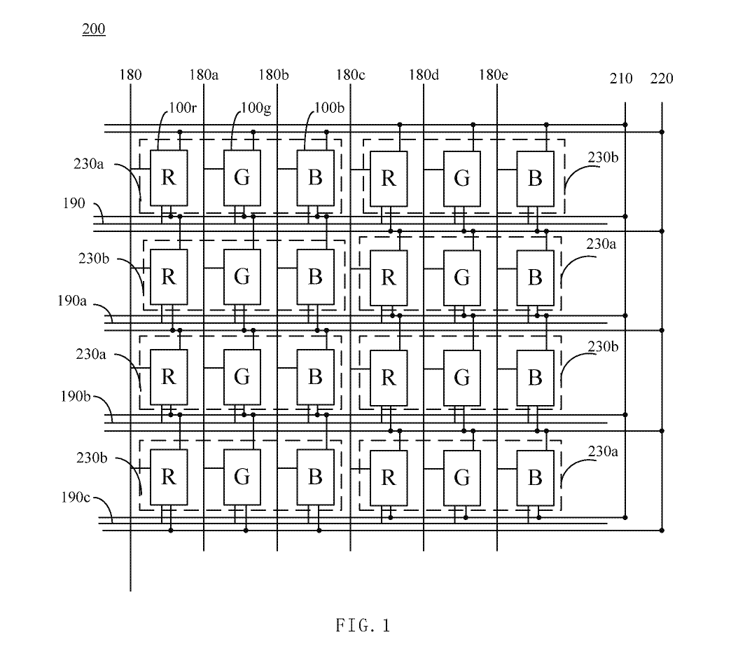

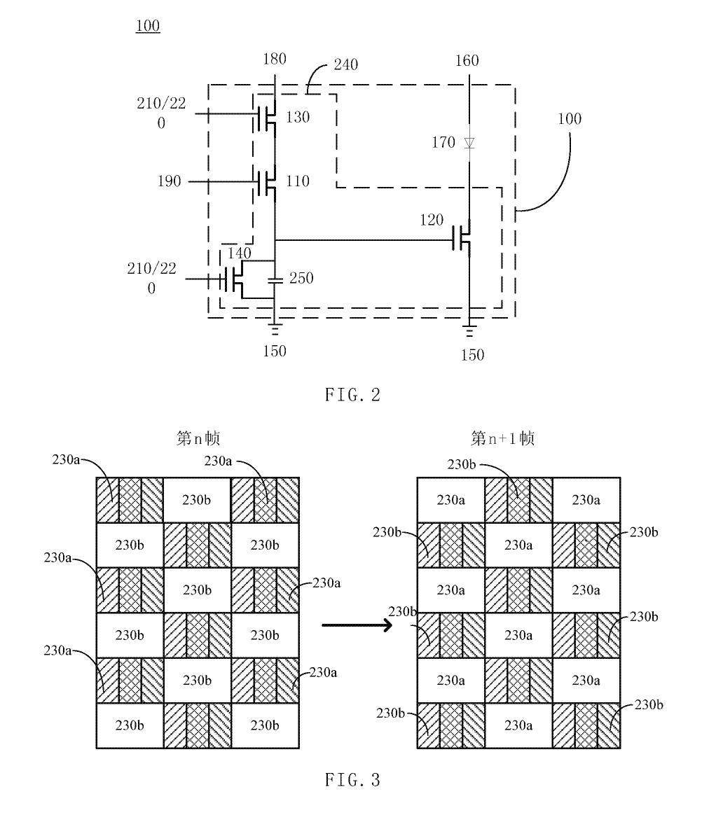

### DETAILED DESCRIPTION OF THE PREFERRED EMBODIMENTS

The following description of each embodiment, with reference to the accompanying drawings, is used to exemplify specific embodiments which may be carried out in the present invention. Directional terms mentioned in the present invention, such as “top”, “bottom”, “front”, “back”, “left”, “right”, “inside”, “outside”, “side”, etc., are only used with reference to the orientation of the accompanying drawings. Therefore, the used directional terms are intended to illustrate, but not to limit, the present invention. In the drawings, components having similar structures are denoted by the same numerals.

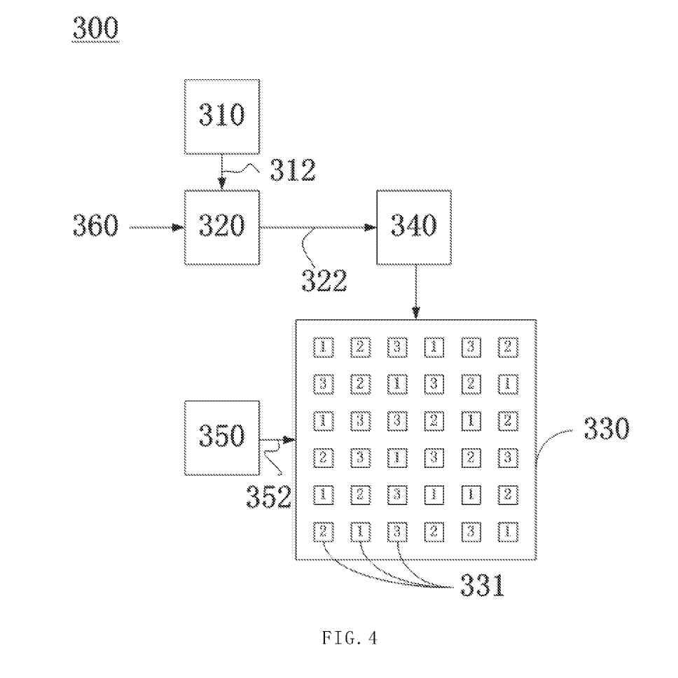

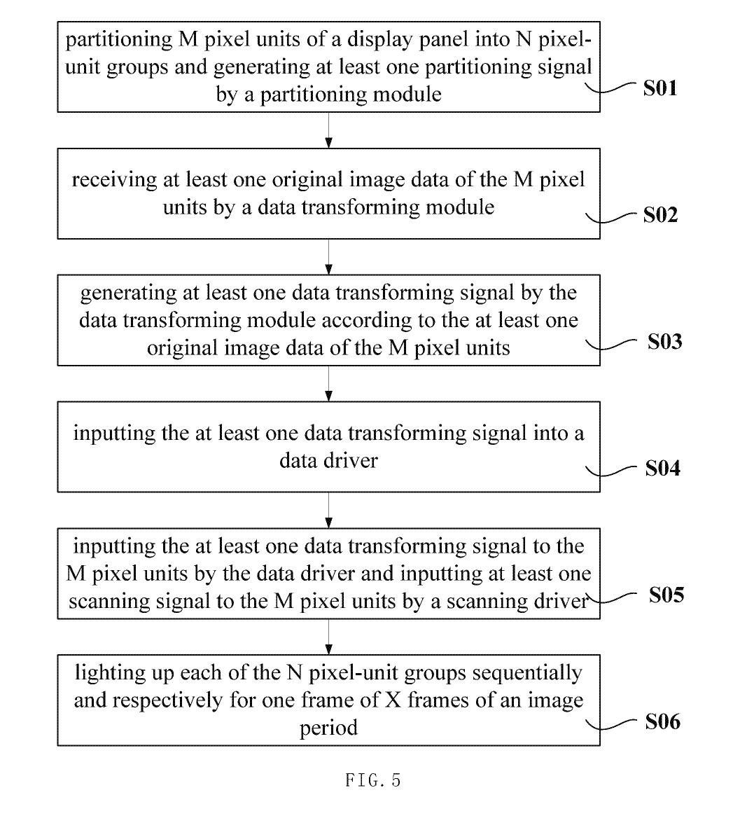

FIG. 4 is a drawing of a display device 300 of the present invention. The display device 300 comprises a display panel 330, a partitioning module 310, a data transforming module 320, a scanning driver 350, and a data driver 340.

The display panel 330 comprises M pixel units 331 (for example, 36 (6*6) pixel units are in the preferred embodiment). The partitioning module 310 partitions the M pixel units 331 into N pixel-unit groups (1-3, for example, 3 groups are in the preferred embodiment, a numeral in the pixel unit represents its group) and generates at least one partitioning signal 312. The data transforming module 320 receives at least one original image data 360 of the M pixel units 331 and generates at least one data transforming signal 322. The data driver 340 receives the at least one data transforming signal 322, and transfers the at least one data transforming signal 322 to the M pixel units 331, to light up each of the N pixel-unit groups (1-3) only for one frame of X frames of an image period (in one preferred embodiment, an image period has 3 frames). For example, at the first frame, the first pixel-unit group (1) lights up; at the second frame, the second pixel-unit group (2) lights up; at the third frame, the third pixel-unit group lights up. After actual experiments, while X is equal to N, the image flicker problem has relative improvement.

The partitioning module 310 generates the N pixel-unit groups (1-3) according to a random number table. Hence, each group of the N pixel-unit groups (1-3) may not have the same lighting sequence in different image periods (such as two adjacent image periods). For example, in different image periods, the second pixel-unit group (2) of the preferred embodiment can light up at the first frame, the first pixel-unit group (1) of the preferred embodiment can light up at the third frame, and the third pixel-unit group (3) of the preferred embodiment can light up at the second frame. Or, in different image periods, each group of the N pixel-unit groups (1-3) may not have the same pixel units so long as each of the M pixel units 331 light up only once in an image period.

Moreover, a pixel unit amount of each of the N pixel-unit groups (1-3) is equal to M divided by N. In the preferred embodiment, M is equal to 36, N is equal to 3, and hence, the pixel unit amount of each of the N pixel-unit groups (1-3) is 12. While M is unable to be evenly divided by N, an approximate integer is fine so long as each of the M pixel units 331 light up only once per image period.

In detail, the at least one data transforming signal 322 is generated according to the at least one original image data 360 of the M pixel units 331 and the at least one partitioning signal 312 by using the data transforming module 320.

FIG. 5 is a flow diagram of a display method of the present invention. Please kindly refer to FIG. 4 for the numeral of the elements, no description is mentioned again. The method comprises:

First, processing a step S01, M pixel units 331 of a display panel 330 are partitioned into N pixel-unit groups (1-3) and at least one partitioning signal 312 is generated by a partitioning module 310; then, processing a step S02, at least one original image data 360 of the M pixel units 331 is received by a data transforming module 320; then, processing a step S03, at least one data transforming signal 322 is generated by the data transforming module 320 according to the at least one original image data 360 of the M pixel units 331 group; then, processing a step S04, the at least one data transforming signal 322 is inputted into a data driver 340; then, processing a step S05, the at least one data transforming signal 322 is inputted to the M pixel units 331 by the data driver 340 and at least one scanning signal is inputted to the M pixel units by a scanning driver 350; finally, processing a step S06, each of the N pixel-unit groups (1-3) lights up sequentially and respectively for one frame of X frames of an image period.

After actual experiments, while X is equal to N, the image flicker problem has relative improvement.

In the present invention, no change is made to the scanning signal, the technical effect is achieved only with data signal processing.

Although the present invention has been disclosed as preferred embodiments, the foregoing preferred embodiments are not intended to limit the present invention. Those of ordinary skill in the art, without departing from the spirit and scope of the present invention, can make various kinds of modifications and variations to the present invention. Therefore, the scope of the claims of the present invention must be defined.

1. A display device, comprising:
a display panel, comprising M pixel units;
a partitioning module for partitioning the M pixel units into N pixel-unit groups and generating at least one partitioning signal;
a data transforming module for receiving at least one original image data of the M pixel units and generating at least one data transforming signal; and
a data driver for receiving the at least one data transforming signal, and transferring the at least one data transforming signal to the M pixel units to light up each of the N pixel-unit groups only for one frame of X frames of an image period;
wherein N is equal to X.

2. The display device according to claim 1, wherein the partitioning module generates the N pixel-unit groups according to a random number table.

3. The display device according to claim 1, wherein the data transforming module generates the at least one data transforming signal according to the at least one original image data of the M pixel units and the at least one partitioning signal.

4. The display device according to claim 1, wherein N is greater than or equal to 2.

5. A display device, comprising:
a display panel, comprising M pixel units;
a partitioning module for partitioning the M pixel units into N pixel-unit groups and generating at least one partitioning signal;
a data transforming module for receiving at least one original image data of the M pixel units and generating at least one data transforming signal; and
a data driver for receiving the at least one data transforming signal, and transferring the at least one data transforming signal to the M pixel units, to light up each of the N pixel-unit groups only for one frame of X frames of an image period.

6. The display device according to claim 5, wherein the partitioning module generates the N pixel-unit groups according to a random number table.

7. The display device according to claim 5, wherein the data transforming module generates the at least one data transforming signal according to the at least one original image data of the M pixel units and the at least one partitioning signal.

8. The display device according to claim 5, wherein N is greater than or equal to 2.

9. A display method, comprising:
partitioning M pixel units of a display panel into N pixel-unit groups and generating at least one partitioning signal by a partitioning module;
receiving at least one original image data of the M pixel units by a data transforming module;
generating at least one data transforming signal by the data transforming module according to the at least one original image data of the M pixel units;
inputting the at least one data transforming signal into a data driver;
inputting the at least one data transforming signal to the M pixel units by the data driver and inputting at least one scanning signal to the M pixel units by a scanning driver; and
lighting up each of the N pixel-unit groups sequentially and respectively for one frame of X frames of an image period.

10. The display method according to claim 9, wherein the partitioning module generates the N pixel-unit groups according to a random number table.

11. The display method according to claim 9, wherein the data transforming module generates the at least one data transforming signal according to the at least one original image data of the M pixel units and the at least one partitioning signal.

12. The display method according to claim 9, wherein N is greater than or equal to 2.
